(19) United States
(12) Patent Application Publication
(10) Pub. No.: US 2026/0003695 A1
(43) Pub. Date: Jan. 1, 2026

(54) EXPERT LOAD BALANCING IN TRANSFORMER MODELS

(71) Applicants: ADVANCED MICRO DEVICES, INC., Santa Clara, CA (US); Xilinx, Inc., San Jose, CA (US)

(72) Inventors: Venkata Pavan Kumar Miriyala, Chai Chee Road (SG); Lucian Petrica, Dublin (IE); Kenneth O'Brien, Dublin (IE)

(21) Appl. No.: 18/758,261

(22) Filed: Jun. 28, 2024

(51) Int. Cl. G06F 9/50

(52) U.S. Cl. CPC G06F 9/505; G06F 9/5083

(57) ABSTRACT

In response to one or more conditions, a processing system determines whether transferring one or more experts to different processing units would improve load balancing at the processing system. The processing system determines an amount of variance between the utilization for each expert relative to the average utilization of all experts at their currently-assigned processing units. The processing system then measures the amount of variance under one or more different configurations of expert-processing unit assignments. If so, the processing system transfers one or more of the experts to different processing units.

### BACKGROUND

Transformer models are neural networks employed in a variety of machine learning applications, including natural language processing, training of large language models, as well as audio and multi-modal processing. To enhance performance, some transformer models employ a mixture of experts (MoE) approach, wherein the transformer model includes a plurality of relatively small feed-forward neural networks, each referred to as an expert. The transformer model includes a self-attention layer and a normalization layer than provide tokens to an MoE layer, wherein the MoE layer includes a gating function and a group of experts. For each input token, the gating function selects one or more experts to process each token. The transformer model then aggregates the expert outputs for each input token to generate the MoE layer output, which in turn is fed to another layer of the transformer model or is provided as the model output. By employing MoE layers instead of dense feed-forward neural networks, the transformer model increases model capacity (the number of parameters) without a corresponding increase in the model inference time.

To enhance the efficiency of the MoE layer, some transformer models employ expert parallelism, wherein different experts are executed at different processing nodes of a processing system. For example, a transformer model is sometimes implemented at a processing system with multiple processing nodes, wherein each node includes at least one parallel processing unit, such as a graphics processing unit. The nodes are connected by a communication fabric of the processing system. Different experts are assigned to the different processing units and, when a gating function selects a particular expert to process a token, the processing system sends the token to the corresponding processing unit over the communication fabric. This allows experts to be executed in parallel, improving processing efficiency. However, existing approaches to assigning experts to the processing units can negatively impact transformer model accuracy, latency, and energy efficiency.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that transfers one or more experts of a transformer model to different processing units based on expert utilization in accordance with some embodiments.

FIG. 2 is a diagram illustrating an example of the processing system of FIG. 1 transferring experts to different processing units based on expert utilization.

FIG. 3 is a block diagram illustrating aspects of the processing system of FIG. 1 that support load balancing of experts in accordance with some embodiments.

FIG. 4 is a block diagram illustrating an example of the processing system of FIG. 1 transferring an expert to a different processing unit by moving expert weights between memory devices in accordance with some embodiments.

FIG. 5 is a block diagram illustrating an example of the processing system of FIG. 1 measuring utilization of experts at different processing units during an attention computation phase of a processor model in accordance with some embodiments.

FIG. 6 is a flow diagram of a method of load balancing experts of a transformer model at a processing system in accordance with some embodiments.

### DETAILED DESCRIPTION

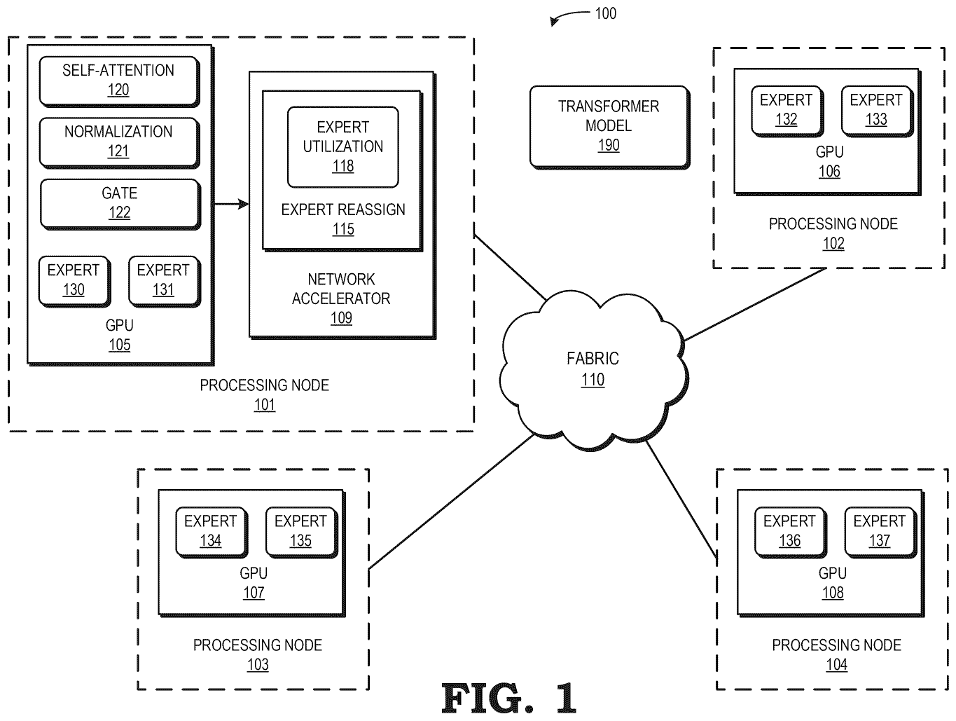

FIGS. 1-6 illustrate example techniques for load balancing transformer model experts at a processing system. Using the disclosed techniques, the processing system transfers one or more experts from one processing unit to a different processing unit based on measured utilization of the experts. By transferring the one or more experts based on measured utilization, the processing system balances the processing workload associated with executing the experts, thereby improving the latency and energy efficiency of the transformer model.

To illustrate, in some cases a transformer model is implemented at a processing system having a plurality of processing nodes. Each processing node includes a parallel processing unit to execute one or more experts of the transformer model. In particular, the transformer model employs a plurality of experts to process tokens provided by self-attention and normalization layers via one or more gating functions. That is, each gating function receives tokens from a corresponding set of self-attention and normalization layers. For each token, the gating function selects, based on the contents of the token, one of the plurality of experts to process the token. To enhance processing efficiency, the transformer model employs expert parallelism, wherein different ones of the experts are executed, in parallel, at different ones of the processing units. Accordingly, after a gating function selects a given token to be processed by an expert, the token is routed to the expert corresponding processing unit via a communication fabric, and the expert processes the received token to generate an output token.

The experts are typically assigned to the different processing units during model initialization. Conventionally, these assignments remain fixed. However, in many cases, these fixed assignments result in an imbalanced processing load at the processing system. For example, in some cases the particular experts being selected by the transformer model change over time, based on changing input tokens, so that at a given time one set of experts experiences relatively high utilization and then at a later time experiences a relatively low utilization. This results in, for example, processing bottlenecks at some processing units when the corresponding experts are experiencing high utilization. Conventionally, these processing bottlenecks are ameliorated by discarding tokens that target high-use experts, by replicating high-use experts in multiple processing nodes/units, or a combination thereof. However, these approaches can reduce model accuracy, increase latency, and increase energy use.

To improve load balancing, the techniques disclosed herein provide a processing system that measures utilization of transformer model experts over time. In response to one or more conditions (e.g., expiration of a timer, measuring a threshold number of utilizations, determining that utilization of an expert exceeds a threshold), the processing system determines whether transferring one or more experts to different processing units would improve load balancing at the processing system. For example, in some embodiments the processing system determines an amount of variance between the utilization for each expert relative to the average utilization of all experts at their currently-assigned processing units. The processing system then measures the amount of variance under one or more different configurations of expert-processing unit assignments. That is, the processing system tests different mappings of the experts to the processing units and determines whether any of the different mappings is expected to result in less variance in expert utilization relative to the average utilization. If so, the processing system transfers one or more of the experts to different processing units, according to the identified mapping. Thus, over time, experts are transferred to different processing units in such a way that the variance of average expert utilization across the different processing nodes is reduced. This in turn improves the overall efficiency of the transformer model, including improving energy efficiency and latency.

FIG. 1 illustrates a processing system 100 that is generally configured to execute a transformer model neural network (referred to herein as a transformer model 190 for simplicity), such as a large language model (LLM), in accordance with some embodiments. Accordingly, in various embodiments, the processing system 100 is part of any one of a number of electronic devices that employ a transformer model, such as a server (or set of servers), a desktop computer, a laptop computer, a game console, a smartphone, and the like.

To execute the transformer model 190, the processing system 100 includes a plurality of processing nodes, designated processing nodes 101-104. It will be appreciated that, in different embodiments, the processing system 100 includes fewer or more processing nodes than are illustrated at FIG. 1. The processing nodes 101-104 are all connected to a communication fabric 110 that is generally configured to communicate data (e.g., messages, packets, or other units of information) between the processing nodes. Accordingly, in different embodiments the communication fabric is an internal processor fabric, such as a Peripheral Component Interconnect Express (PCIe) fabric, a network fabric (e.g., one or more of a local area network and a wide area network (e.g., the Internet), a server interconnect, and the like, or any combination thereof.

Each of the processing nodes includes a set of processing circuitry, as well as supporting circuitry, to execute at least a portion of one or more layers of the transformer model 190. In particular, each of the processing nodes 101 includes at least one processing unit, designated processing units 105-108 respectively. The processing units 105-108 are generally configured to execute operations to implement one or more layers (e.g., self-attention layers, normalization layers, gating functions, and experts) of the transformer model 190. The processing units 105-108 thus include sets of processing elements (e.g., compute units, single-instruction multiple-data (SIMD) units, processor cores, command processors, and the like, or any combination thereof), along with supporting circuitry (caches, schedulers, command buffers, and the like) that collectively execute the sets of operations corresponding to the transformer model layers. For purposes of description, it is assumed that the processing units 105-108 are graphics processing units (GPUs). However, in other embodiments the processing units are any type of parallel processor, such as vector processors, general-purpose GPUs (GPGPUs), non-scalar processors, highly-parallel processors, artificial intelligence (AI) processors, inference engines, machine learning processors, other multithreaded processing units, and the like.

Each of the processing nodes 101 also includes a network accelerator, such as network interface card (NIC) or network switch. For example, the processing node 101 includes a network accelerator 109 (the network accelerators are not illustrated for processing nodes 102-104 for clarity). The network accelerators are generally configured to provide at least a physical layer (or PHY) interface for the corresponding processing unit to communicate with other processing nodes via the fabric 110. As described further herein, in at least some embodiments the network interfaces include additional circuitry to provide additional functionality for the processing system 100, including monitoring of expert utilization and direct memory transfers of data (e.g., expert weights) between the processing nodes 101-104.

In at least some embodiments, the processing nodes 101-104 include additional circuitry not illustrated at FIG. 1. For example, in some embodiments one or more of the processing nodes 101-104 includes a central processing unit (CPU) generally configured to control the operations at one or more of the processing units 105-108 via, for example, the generation of one or more commands that instigate operations at the corresponding processing units. In addition, in some embodiments each of the processing nodes 101-104 includes one or more memory devices (e.g., dynamic random-access memory (DRAM) devices) that are configured to store data on behalf of the processing units, such as weights for one or more layers of the transformer model 190.

The transformer model 190 includes a plurality of layers that each perform specified operations based on a received input token (e.g., words, characters, phrases) to generate a corresponding output token. Examples of the layers include self-attention layers (e.g., self-attention layer 120 executed at the GPU 105), normalization layers (e.g., normalization layer 121 executed at the GPU 105), gating functions (e.g., gating function 122 executed at the GPU 105), and experts (e.g., experts 130-137, executed at various ones of the GPUs 105-108).

To illustrate, in some cases the self-attention layer 120 receives an input token, either from another layer of the transformer model 190 or as initial input token for the transformer model 190. The self-attention layer 120 performs one or more self-attention operations based on the input token and provides the result to the normalization layer 121, which normalizes the resulting token. The gating function 122 selects, based on the normalized token and a specified gating function, one or more of the experts 130-137. Each of the experts 130-137 is a relatively small feed forward neural network having a set of neural network weights (referred to herein as expert weights). Accordingly, the selected ones of the experts 130-137 process the received normalized token according to the corresponding expert weights to generate an output token. The output token is provided to another layer of the transformer model 190, or as an output of the model. Furthermore, in some embodiments the transformer model 190 includes a plurality of self-attention layers, normalization layers, gating functions, and experts chained together to collectively execute the model.

To enhance the efficiency of the transformer model, the processing system 100 supports expert parallelism, wherein different ones of the experts are executed, in parallel, at the different processing units 105-108. Thus, in some embodiments, the experts 130-137 are distributed to the different processing units 105-108 during an initialization process for the transformer model 190, and according to an initial mapping (not shown) determined, for example, during a training or development process for the transformer model 190. Each of the processing nodes 101-104 stores a copy of the initial mapping. In response to a gating function selecting an expert for a token, the processing system routes the token (via the fabric 110) to the processing unit indicated by the initial mapping and the processing unit executes the expert based on the token. To illustrate via an example, in response to the gating function 122 selecting the experts 131 and 135 to process a token, the processing system 100 routes the token to the processing node 103. The experts 131 and 135 are then executed (at the GPUs 105 and 107, respectively) concurrently to process the token. The results are then combined by, for example, an addition and normalization layer (not shown) to generate the output token.

As noted above, in at least some cases the relative utilization of the experts 130-137 changes over time, due to changing input tokens, changing transformer model tasks, changing workloads, different batches within a given workload, and the like, or any combination thereof. In some cases, this results in one subset of experts experiencing high utilization for a period of time while another subset of experts experiences relatively low utilization, resulting in a processing load imbalance if the distribution of the experts across the processing nodes 101-104 remains unchanged.

To reduce the likelihood of such load imbalances, the network interfaces at the processing nodes 101-104 are configured to monitor the routing of tokens to different experts, thereby collecting, at each node, a set of statistics indicating the local utilization of each expert. The network interfaces then aggregate the local utilization statistics to determine an overall, or global, utilization for each of the experts 130-137. Based on the global utilization, the processing system transfers one or more experts between the processing nodes 101-104, so that the variance of utilization of each node, relative to the average utilization, is reduced. That is, the processing system 100 transfers one or more of the experts 130-133 to reduce the difference in expert utilization between the nodes, thereby reducing the latency and energy use of the transformer model 190.

To illustrate, the network accelerator 109 includes expert reassignment circuitry 115, which includes one or more circuits that collectively monitor the experts selected by the gate 122. For example, in some embodiments the gate 122 indicates a selected expert for a token by sending a command to the network accelerator 109 to transfer the token to the processing node corresponding to the selected expert, along with a message indicating the selected expert. The expert reassignment circuitry 115 monitors these expert-designating messages generated by the gate 122 to determine the local utilization of the experts 130-137. The expert reassignment circuitry 115 is also configured to periodically send its local utilization measurements to the other processing nodes, and to receive the respective local utilization measurements from the other processing nodes 102-104. The expert reassignment circuitry 115 then aggregates the local utilization measurements to generate the global expert utilization statistics 118. Accordingly, the global utilization statistics 118 reflect the utilization for each expert over a period of time (that is, the number of times each of the experts 130-137 has processed a token over the period of time). In some embodiments, the expert reassignment circuitry 115 periodically resets the expert utilization statistics 118, or discards utilizations older than a specified threshold, so that the utilization statistics 118 indicate the utilization of each of the experts 130-137 over a sliding window of time, wherein the length of the sliding window is specified, or is programmable.

The expert reassignment circuitry 115 is further configured to periodically analyze the expert utilization statistics 118 and, based on the analysis, transfer one or more of the experts 130-137 to a different processing node. As used herein, transfer includes moving experts from one processing unit to another, and also includes loading an expert from a central location (e.g., a pool of memory shared by the processing nodes) to an individual processing node, such as to a local memory of the processing node, or to a memory that is accessible via the fabric 110. In addition, it will be appreciated that the techniques described herein are, in some embodiments, implemented at an individual processing node. For example, in some embodiments an individual processing node includes multiple processing units (e.g., multiple GPUs) connected via a communication fabric, and one or more experts are transferred between processing units of the individual processing node, such as by transferring the weights of an expert from a memory (e.g., cache) of one processing unit to the memory of another processing unit via the communication fabric. In other embodiments, the experts are transferred between processing units that share the same communication pod. For example, in some embodiments a processing system includes sets of processing units (e.g., GPUs) connected via one or more communication switches, wherein each set of processing units is referred to as a pod. In some cases, experts are transferred between processing units within the same pod, such as by such as by transferring the weights of an expert from a memory (e.g., cache) of one processing unit to the memory of another processing unit via the corresponding communication switches.

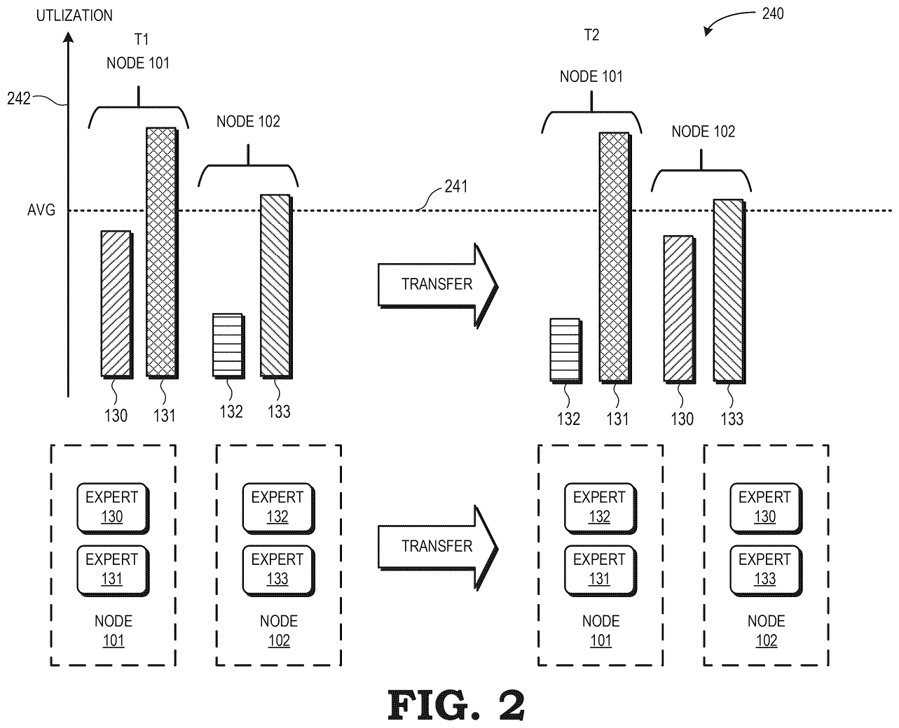

An example of an expert transfer is illustrated at FIG. 2 in accordance with some embodiments. For ease of illustration, the example of FIG. 2 assumes that experts are executed at the processing nodes 101 and 102. FIG. 2 illustrates a histogram 240, representing the expert utilization statistics 118 at the. different times, designated T1 and T2. In particular, the histogram 240 indicates a utilization (as represented by the axis 242) for each of the experts 130-133 over a sliding time window.

In the depicted example, at time T1 the experts 130 and 131 have been executed at the processing node 101 over the most recent time window, while the experts 132 and 133 have been executed at the processing node 102. As shown by the histogram 240, at time T1 the expert 131 has been utilized a relatively high number of times (that is, has been executed on a high number of input tokens), while the expert 130 has been executed a lower number of times. In addition, at the processing node 102, the expert 132 has been executed a relatively low number of times, and the expert 133 has been executed a somewhat higher number of times, but lower than the number of times the expert 131 has been executed. Accordingly, the total utilization of experts 130 and 131 is much larger than the total utilization of experts 132 and 133. Without rebalancing of the experts, this would result in processing node 102 completing expert processing much earlier than processing node 101, such that processing node 102 is likely to be idle for a relatively long amount of time.

At time T1, the expert reassignment circuitry 115 determines that the utilization of the experts 130 and 131 varies from the average utilization of all the experts (as represented by the line 241) by more than a threshold amount. In response, the expert reassignment circuitry 115 determines, for each possible combination of expert assignments at the processing nodes 101 and 102, the variance from the average utilization, and determines which combination of expert assignments results in the lowest variance. For the example of FIG. 2, it is assumed that the lowest variance results from the expert 132 being executed at the processing node 101 and the expert 130 being executed at the processing node 102. Accordingly, the expert reassignment circuitry 115 transfers the weights of the expert 132 to the processing node 101 (e.g., by issuing a direct memory access command that transfers the weights of the expert 132 to a memory of the GPU 106). In addition, the expert reassignment circuitry 115 transfers the weights of the expert 130 to the processing node 102.

Thus, at time T2, the processing node 101 is assigned to execute the experts 131 and 132, and the processing node 102 is assigned to execute the experts 130 and 133. Assuming that the experts continue to be executed according to a similar pattern as prior to time T1, this new configuration of experts results in improved load balancing at the processing nodes 101 and 102. In particular, because of the load balancing, the variance in the utilization of each of the processing nodes 101 and 102 during expert processing is reduced, such that neither of the processing nodes 101 and 102 are likely to be idle for a long period of time. This in turn reduces latency of the transformer model 190 (e.g., because of fewer processing bottlenecks), and reduces energy consumption (e.g., because the processing nodes are not oversubscribed to handle a high number of tokens), and improves accuracy of the transformer model 190 relative to conventional approaches (e.g., because tokens are not discarded).

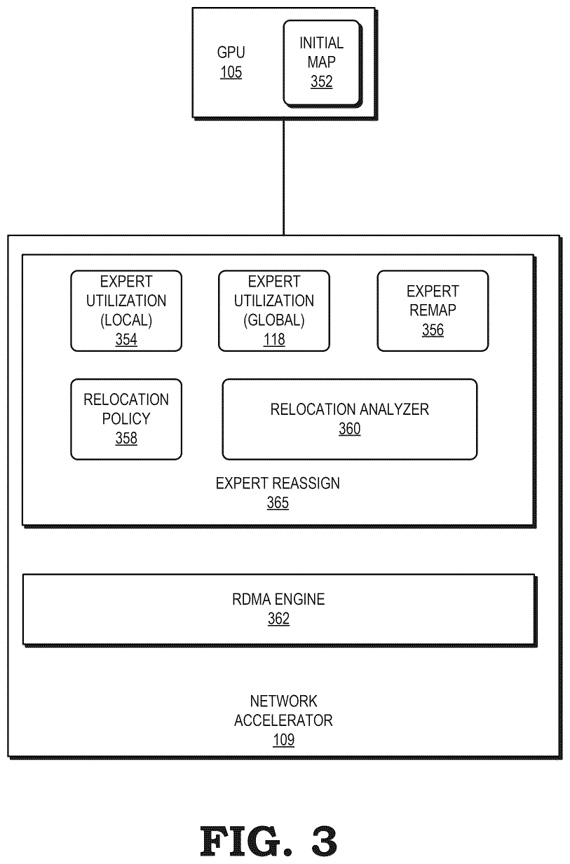

FIG. 3 is a block diagram illustrating additional aspects of the GPU 105 and the network accelerator 109 of FIG. 1. In the illustrated example, the GPU 105 stores (e.g., at a local memory (not shown)) an initial map 352, representing an initial configuration of the assignments of the experts 130-137 at the processing nodes 101-104. Thus, in some embodiments, during an initialization phase the transformer model 190 issues commands to the processing system 100 to load the weights of the different experts 130-137 to the processing nodes as indicated by the initial map 352. In response to a gate function (e.g., gate function 122) selecting an expert to process a token, the GPU 105 sends a command to the network accelerator 109 to provide the token to the expert at the processing node indicated by the initial map 352.

The network accelerator 109 includes a number of circuits and data to support reassignment of experts from the initial map 352. In particular, the network accelerator 109 includes a remote direct memory access (RDMA) engine 362 that is circuitry configured to execute RDMA commands to, for example, transfer tokens between processing nodes, transfer expert weights between processing nodes, and the like. Thus, in response to receiving a command (e.g., from the GPU 105), to transfer a token to another processing node, the RDMA engine 362 issued an RDMA command that transfers the data representing the token from a memory of processing node 101 to the memory of the other processing node. It will be appreciated that the use of an RDMA engine is an example only, and that in other embodiments other circuitry is employed to move data, including expert weights, between processing nodes. For example, in some embodiments the RDMA engine 362 is a DMA engine.

The network accelerator 109 also includes expert reassignment circuitry 365 that is generally configured to measure the utilization of the experts 130-137 and, based on the measured utilization, reassign one or more of the experts to a different processing node. In particular, the expert reassignment circuitry 365 monitors communications from the GPU 105 and identifies commands to send tokens to one or more of the experts 130-137. Based on these commands, the expert reassignment circuitry determines a local count of the use of each expert, and stores these counts as the local expert utilization 354. In addition, the expert reassignment circuitry 365 periodically sends the local expert utilization 354 to NICs at the other processing nodes 102-104 and receives copies of the corresponding local expert utilizations from each of the other processing nodes 102-104. The expert reassignment circuitry 365 aggregates the different local expert utilizations (including the local expert utilization 354) to determine the global expert utilization 118. The global expert utilization 118 thus indicates the total utilization of the experts 130-137 by all of the processing nodes 101-104.

The expert reassignment circuitry 365 includes relocation analyzer circuitry 360 configured to analyze the global expert utilization 118 and, based on the analysis, identify one or more experts to be relocated. For example, in some embodiments the relocation analyzer circuitry 360 determines, based on the global expert utilization 118, the variance between the utilization of each of the experts 130-137 and the average utilization of all the experts. The relocation analyzer circuitry 360 further determines, for each of a set of possible reassignments of the experts 130-137 to different processing nodes, the expected variance between the utilization of each of the experts 130-137 and the average utilization of all the experts. The relocation analyzer circuitry 360 selects the reassignments that result in minimal variance between the utilization of each of the experts 130-137 and the average utilization of all the experts and stores the resulting assignment of experts as the expert remap 356. That is, the expert remap 356 represents the assignment of experts to the different processing nodes 101-104 as selected by the relocation analyzer 360 and is (at least in some cases) different from the initial map 352.

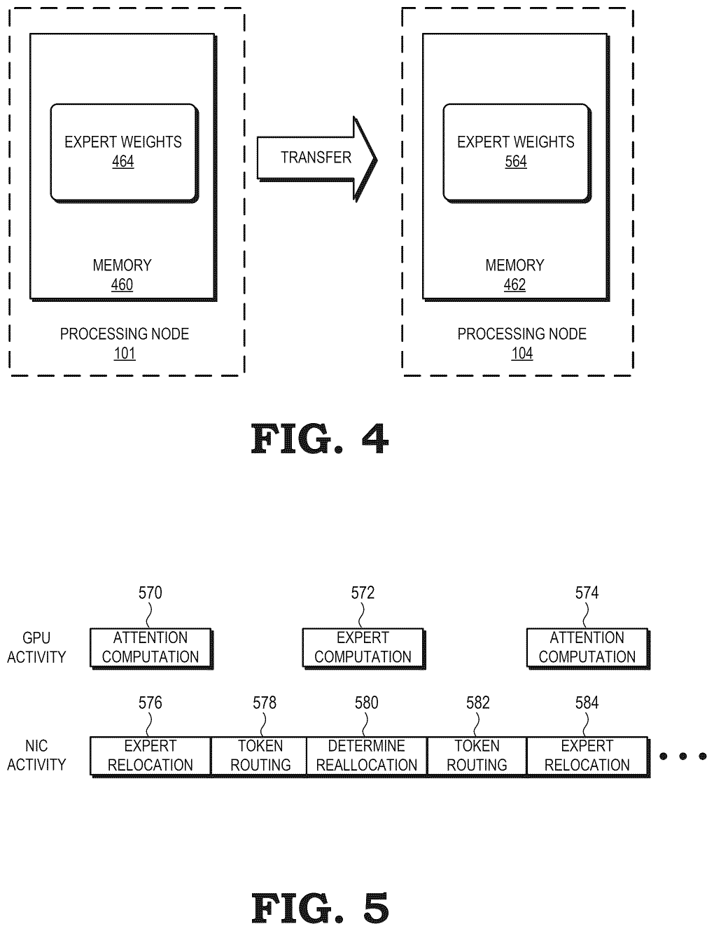

Based on the expert remap 356, the expert reassignment circuitry 365 sends one or more commands to the RDMA engine to initiate RDMA transfers of the weights associated with one or more experts, so that the assignment and execution of experts at the processing nodes 101-104 matches the expert remap 356. An example is illustrated at FIG. 4 in accordance with some embodiments. In the illustrated example, the expert weights 464, corresponding to the expert 131, are transferred (based on an RDMA command) from a memory 460 of the processing node 101 to a memory 462 of the processing node 104. This effectively transfers the expert 131 from the processing node 101 to the processing node 104.

Returning to FIG. 3, as noted above, the GPU 105 is configured to send tokens to one or more of the experts 130-137 based on the initial map 352 by sending a command to the network accelerator 109. The expert reassignment module circuitry 365 is configured to intercept those commands and modify them to reflect the expert remap 356, so that the token is sent to the expert at the correct processing node. For example, in some embodiments the initial map indicates that the expert 132 is located at the processing node 102. Later, based on the global expert utilization 118, the expert reassignment circuitry 365 transfers the expert 132 to the processing node 103, and indicates the reassignment in the expert remap 356. In response to the GPU 105 sending a command to transfer a token to the expert 132 at the processing node 102, the expert reassignment circuitry 365 modifies the command, based on the expert remap 356, to transfer the token to the expert 132 at the processing node 103. Thus, the expert reassignment circuitry 365 allows experts to be transferred to different processing nodes without requiring updates to the different processing units 105-108.

In the example of FIG. 3, the expert reassignment circuitry 365 includes a relocation policy 358, representing specified or programmable policy information that determines how the expert reassignment circuitry operates, how one or both of the expert utilizations 154 and 118 are determined, how the relocation analyzer circuitry 360 determines the expert remap 356, and the like, or a combination thereof. For example, in some embodiments the relocation policy 358 designates one or more of the experts 130-137 to be excluded from being transferred. This is useful, for example, when one of the processing nodes has been specially designed or programmed to execute a particular one of the experts 130-137.

The transfer of one or more experts between processing nodes consumes communication bandwidth (e.g. of the fabric 110), memory bandwidth, and other resources. In some cases, this diverts resources from other layers of the transformer model 190, or otherwise delays execution of the model. To ameliorate such delays, in some embodiments the processing system 100 transfers the one or more experts while the processing nodes 101-104 are performing operations that do not consume, for example, bandwidth of the communication fabric 110 or other resources. An example is illustrated at FIG. 5 in accordance with some embodiments. In the example of FIG. 5, the transformer model 190 is implemented at the GPUs (e.g., GPU 105) according to repeating sets of phases, the sets each including an attention computation phase (e.g., attention computation phase 570) followed by an expert computation phase (e.g., expert computation phase 572. During an attention computation phase, the GPUs 105-108 execute one or more self-attention layers, normalization layers, gating functions, or a combination thereof. During an expert computation phase, the GPUs 105-108 execute one or more of the experts 130-137.

In addition, the NICs of the processing nodes 101-104, such as network accelerator 109, also execute operations according to repeating sets of phases, wherein each of the sets includes an expert relocation phase (e.g., expert relocation phase 576), followed by a token routing phase (e.g., token routing phase 578), followed by a reallocation determination phase (e.g., reallocation determination phase 580), followed by another token routing phase (e.g., token routing phase 582). During the expert relocation phase, the NICs send commands (e.g. RDMA commands) to transfer one or more of the experts 130-137 from their current processing node to a different processing node, to match the expert remap 356. During the token routing phase, based on commands received from the corresponding GPUs and further based on the expert remap 356, the NICs send tokens to the experts 130-137, at the corresponding processing nodes, for processing. During the reallocation determination phase, the NICs employ the global expert utilization 118 to determine which (if any) of the experts 130-137 are to be transferred and to which processing nodes they are to be transferred.

In some embodiments, the GPUs 105-108 coordinate with the corresponding NICs so that, as illustrated at FIG. 5, the attention computation phase is executed concurrently with the expert relocation phase. Thus, for example, the attention computation phase 570 is executed concurrently with the expert relocation phase 576, and the attention computation phase 574 is executed concurrently with the expert relocation phase 584. Because the attention computation phase typically does not consume much bandwidth of the fabric 110, this concurrent execution ensures that transfer of the experts to different processing nodes does not substantially delay or introduce latency in the execution of the transformer model 490.

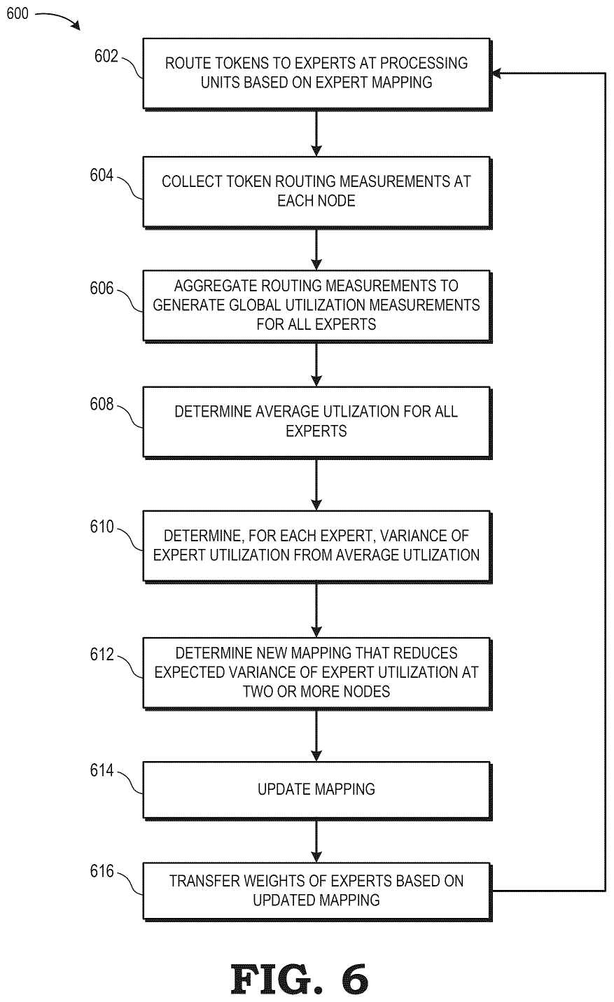

FIG. 6 is a flow diagram of a method 600 of load balancing execution of transformer model experts at a processing system in accordance with some embodiments. The method 600 is described with respect to an example implementation at the processing system 100 of FIG. 1, but it will be appreciated that in other embodiments the method 600 is implemented at processing systems having different configurations.

At block 602, the NICs of the processing nodes 101-104 route tokens to the experts 130-137 based on requests received from the corresponding GPUs and the expert remap 356. For example, the network accelerator 109 receives requests from the GPU 105 to send one or more tokens to one or more of the experts 130-137. These requests indicate the location of each expert according to the initial map 352. The expert reassignment circuitry 365 modifies each request, based on the expert remap 356, to reflect the current processing node of the corresponding network. The network accelerator 109 then satisfies the modified request by sending the token to the indicated processing node, and the GPU at the processing node executes the designated expert based on the token.

At block 604, each of the NICs collects token routing measurements based on the requests received from the corresponding GPU and stores the measurements as local expert utilization. Thus, for example, the expert reassignment circuitry 365 monitors the requests received from the GPU 105 to route tokens to designated ones of the experts 130-137, and based on those requests determines the local utilization 354. For example, in some embodiments, in response to identifying a request to send a token to a designated expert, the expert reassignment circuitry 365 increments a utilization count for the designated expert at the local expert utilization 354. In addition, the expert reassignment circuitry 365 periodically decrements the utilization count for each of the experts at the local expert utilization 354. This ensures that the local expert utilization 354 indicates the local utilization for each expert over a sliding window of time.

At block 606, each of the NICs provides the corresponding local expert utilization to the other NICs. Each of the NICs then aggregates the local expert utilizations to form a copy of the global expert utilization 118. At block 608, each of the NICs determines, based on the global expert utilization, the average of expert utilization across all of the experts 130-137. At block 610, each of the NICs determines, based on the global expert utilization and for each expert, the variance of the utilization of the expert from the average. Each of the NICs then determines the total variance of utilization from the average across all the experts.

At block 612, each of the NICs determines a new mapping of experts that reduces the expected variance of expert utilization at two or more of the processing nodes 101-104. For example, in some embodiments each of the NICs determines a set of different assignments for the experts 130-137 so that under each assignment at least one expert is assigned to a different processing node than the other assignments and at least one expert is assigned to a different processing node than under the current mapping. Each network accelerator then determines the total variance of utilization for the experts 130-137 relative to the average utilization. Each network accelerator then selects the set of assignments that minimizes the total variance. At block 614 each of the NICs updates the corresponding expert remap (e.g., expert remap 356) to reflect the selected set of assignments. At block 616 the NICs collectively issue RDMA commands to transfer the weights for one or more of the experts 130-137 to one or more of the processing nodes 101-104, so that each of the experts are located at the processing node indicated by the expert remap. The method then returns to block 602.

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
determining a first utilization of a first expert of a transformer model at a first processing unit of a processing system; and
transferring the first expert to a second processing unit of the processing system based on the first utilization.

2. The method of claim 1, wherein determining the first utilization comprises:
determining, for each expert of a plurality of experts of the transformer model, a corresponding utilization of the expert.

3. The method of claim 2, wherein transferring the first expert comprises:
transferring the first expert based on a second utilization of a second expert.

4. The method of claim 3, wherein the second expert is executed at the second processing unit.

5. The method of claim 4, wherein the first utilization is higher than the second utilization.

6. The method of claim 2, wherein transferring the first expert comprises:
transferring the first expert in response to determining that transferring the first expert reduces variance in average utilization of the plurality of experts.

7. The method of claim 1, wherein transferring the first expert comprises transferring a set of weights of the first expert from a first memory associated with the first processing unit to a second memory associated with the second processing unit.

8. The method of claim 1, wherein transferring the first expert comprises:
transferring the first expert during a self-attention calculation period of the transformer model.

9. A method, comprising:
determining, for each expert of a plurality of experts of a transformer model, a corresponding utilization to generate a plurality of utilizations; and
transferring, based on the plurality of utilizations, a first expert of the plurality of experts from a first processing unit to a second processing unit of a processing system.

10. The method of claim 9, wherein transferring the first expert comprises:
determining a first average utilization for each of a plurality of processing units before the transfer;
predicting a second average utilization for each of the plurality of processing units expected after the transfer; and
transferring the first expert based on the first average utilization and the second average utilization.

11. The method of claim 10, wherein transferring the first expert comprises:
transferring the first expert in response to determining that a variance of the second average utilization is less than a variance of the first average utilization.

12. The method of claim 9, further comprising:
transferring, based on the plurality of utilizations, a second expert of the plurality of experts from a third processing unit to the first processing unit.

13. A processing system, comprising:
a first processing unit;
a second processing unit; and
expert reassignment circuitry configured to:
determine a first utilization of a first expert of a transformer model at a first processing unit of a processing system; and
transfer the first expert to a second processing unit of the processing system based on the first utilization.

14. The processing system of claim 13, wherein the expert reassignment circuitry is to determine the first utilization by:
determining, for each expert of a plurality of experts of the transformer model, a corresponding utilization of the expert.

15. The processing system of claim 14, wherein the expert reassignment circuitry is to:
transfer the first expert based on a second utilization of a second expert.

16. The processing system of claim 15, wherein the second expert is executed at the second processing unit.

17. The processing system of claim 16, wherein the first utilization is higher than the second utilization.

18. The processing system of claim 14, wherein the expert reassignment circuitry is to:
transfer the first expert in response to determining that transferring the first expert reduces variance in average utilization of the plurality of experts.

19. The processing system of claim 13, wherein the expert reassignment circuitry is transfer the first expert by transferring a set of weights of the first expert from a first memory associated with the first processing unit to a second memory associated with the second processing unit.

20. The processing system of claim 13, wherein the expert reassignment circuitry is to:
transfer the first expert during a self-attention calculation period of the transformer model.
